(19) United States
(12) Patent Application Publication
(10) Pub. No.: US 2009/0076774 A1
(43) Pub. Date: Mar. 19, 2009

(54) Probe information collection and distribution systems, methods, and programs

(75) Inventor: Takayuki Miyajima, Anjo-shi (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/230,539

(22) Filed: Aug. 29, 2008

(30) Foreign Application Priority Data
Sep. 18, 2007 (JP) 2007-241330

(51) Int. Cl. G06F 17/18; G06F 15/00

(52) U.S. Cl. 702/179; 702/187

(57) ABSTRACT

Probe information collection and distribution systems, methods, and programs obtain a vehicle attribute from an onboard device in a vehicle that specifies an attribute of the vehicle and probe information of a measured vehicle behavior. The systems, methods, and programs accumulate the probe information in a memory. The systems, methods, and programs obtain an accumulated quantity of the probe information for each of a plurality of categories included in the vehicle attribute and determine one of the plurality of categories for which statistics of the probe information will be calculated based on the accumulated quantity of the probe information. The systems, methods, and programs calculate the statistics of the probe information of the determined category, generate distribution data based on the calculated statistics, and send the distribution data to the onboard device of the vehicle belonging to the determined category.

### INCORPORATION BY REFERENCE

The disclosure of Japanese Patent Application No. 2007-241330, filed on Sep. 18, 2007, including the specification, drawings, and abstract is incorporated herein by reference in its entirety.

### BACKGROUND

1. Related Technical Fields

Related technical fields include statistical processing servers and methods and programs for collecting statistically processing probe information.

2. Related Art

The development of intelligent transport systems has been progressing in recent years with the aim of achieving smooth automobile travel. For example, there is a system in which measurement data is obtained from a communications device installed in the automobile (hereinafter referred to as probe information). Such probe information may include a vehicle position, speed, direction, whether windshield wipers are on or off, and the like. A server that collected the probe information executes statistical processing of the probe information and generates traffic congestion information, weather information, and the like. The server also distributes the generated traffic congestion and other information to a terminal used by a vehicle or user targeted for distribution.

An example of such a system is described in Japanese Patent Application Publication No. JP-A-2005-195536. Driving history information includes driving route information regarding driving routes on which the automobile has driven and driving operation information regarding driving operations performed during the driving on the driving routes. The driving history information is accumulated in association with vehicle specifying information, which includes information about the model and type of the automobile. The accumulated information can then be used by a user computer installed in a vehicle. If a user selects driving history information in which the vehicle model and type match those of the user, the selected driving history information is downloaded and the user computer then performs driving support processing based on the downloaded driving history information.

### SUMMARY

However, although the driving history information is selected according to the vehicle model and type in the above system, such driving history information is the driving history information for only one driver. Therefore, the information may be biased toward that driver's mode of operation, and thus may not be the most appropriate information for the user. In addition, because the state of the vehicle differs even among identical vehicle models and types depending on use conditions such as age and mileage, selection of the model and type alone may not ensure that the most appropriate information is obtained for the user.

Exemplary implementations of the broad inventive principles described herein provide a statistical processing server, a probe information statistical method, and a probe information statistical program which are capable of distributing to a vehicle distribution information that matches a vehicle characteristic, as well as maintaining the accuracy of the distribution information.

Exemplary implementations provide probe information collection and distribution systems, methods, and programs obtain a vehicle attribute from an onboard device in a vehicle that specifies an attribute of the vehicle and probe information of a measured vehicle behavior. The systems, methods, and programs accumulate the probe information in a memory. The systems, methods, and programs obtain an accumulated quantity of the probe information for each of a plurality of categories included in the vehicle attribute and determine one of the plurality of categories for which statistics of the probe information will be calculated based on the accumulated quantity of the probe information. The systems, methods, and programs calculate the statistics of the probe information of the determined category, generate distribution data based on the calculated statistics, and send the distribution data to the onboard device of the vehicle belonging to the determined category.

### BRIEF DESCRIPTION OF THE DRAWINGS

Exemplary implementations will now be described with reference to the accompanying drawings, wherein:

FIG. 1 is a schematic diagram of an exemplary distribution system;

FIG. 2 is a block diagram of an exemplary navigation device;

FIG. 3A is a conceptual diagram of exemplary vehicle attribute data, and

FIG. 3B is a conceptual diagram of exemplary probe data;

FIG. 4 is a block diagram of an exemplary statistical server;

FIG. 5 is a conceptual diagram for explaining a category hierarchy;

FIG. 6 is a schematic diagram of exemplary distribution data;

FIG. 7 is a flowchart of an exemplary data collection method;

FIG. 8 is a flowchart of an exemplary statistical processing method;

FIG. 9 is a flowchart of an exemplary distribution data sending method; and

FIGS. 10 and 11 are flowcharts of an exemplary statistical processing method.

### DETAILED DESCRIPTION OF EXEMPLARY IMPLEMENTATIONS

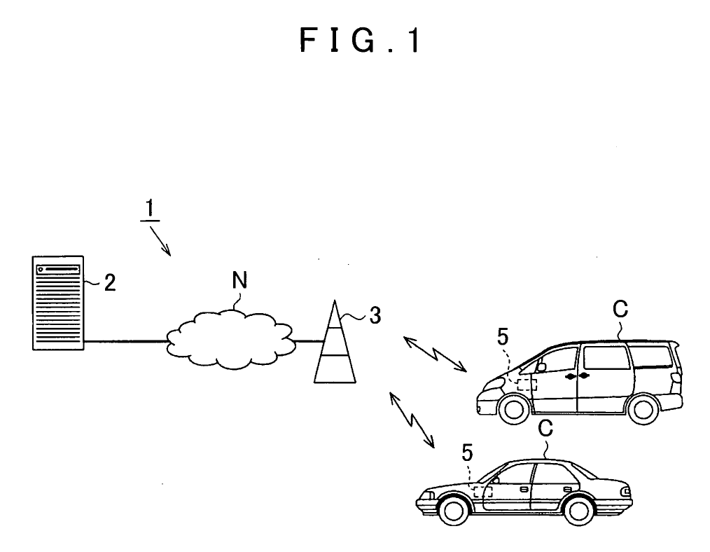

FIG. 1 is a schematic diagram of a statistical system 1 according to the present example. As illustrated in FIG. 1, the statistical system 1 has a statistical server 2 acting as a statistical processing server, a base station 3, and a navigation device 5 acting as an onboard device installed in vehicles C. The statistical server 2 is connected with the navigation devices 5 installed in the vehicles C via a network N such as the Internet or dedicated line in a manner that enables the sending and receiving of various data. The base station 3 is set in predetermined areas, and sends an identifier specifying the area to the vehicles C. The navigation device 5 then sends the received area identifier and a vehicle identifier to the statistical server 2 via the base station 3. The statistical server 2 sequentially identifies the area in which the vehicle C is traveling based on the received area identifier and vehicle identifier.

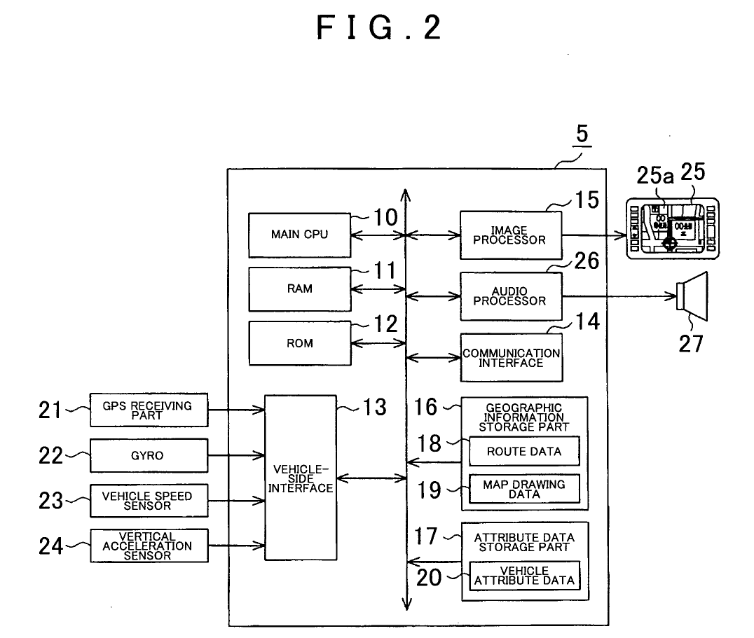

A configuration of the navigation device 5 will be explained next with reference to FIG. 2. The navigation device 5 includes a main controller (CPU 10), a RAM 11, a ROM 12, a vehicle-side interface (I/F) 13, a communication interface (I/F) 14, an image processor 15, a geographic information storage part 16, an attribute data storage part 17, and an audio processor 26.

The main CPU 10 is input with an absolute position detection signal from the GPS receiving part 21 via the vehicle-side I/F 13, and calculates the latitude and longitude of the vehicle C. In addition, the main CPU 10 is also input with various signals from the gyro 22 and the vehicle speed sensor 23 to detect a host vehicle position based on autonomous navigation, which is used in combination with an absolute position from the GPS receiving part 21 to identify the host vehicle position.

Additionally, the main CPU 10 is input with an electric signal from the vertical acceleration sensor 24 via the vehicle-side I/F 13. The vertical acceleration sensor 24 is attached to a vehicle body on a suspension spring of the vehicle C. Furthermore, the vertical acceleration sensor 24 detects a vertical acceleration on the spring, and outputs an electric signal corresponding to the vertical acceleration to the main CPU 10. Based on the magnitude of the vertical acceleration, the main CPU 10 determines a magnitude of vibration experienced by the vehicle C.

The communication I/F 14 is an interface for sending and receiving various data to and from the statistical server 2. The geographic information storage part 16 is an external storage medium such as a hard disk, and stores route data 18 for searching a route to a destination and map drawing data 19 for outputting a map screen 25a to a display 25.

Using the route data 18, the main CPU 10 searches for a recommended route that connects the destination and a current host vehicle position. The main CPU 10 also uses the host vehicle position and the map drawing data 19 to perform map matching that identifies the vehicle C on a road. Namely, the map drawing data 19 has, in addition to drawing data for drawing a map, road shape data for drawing the road the same as it is in the real world. The main CPU 10 calculates a travel trajectory based on the gyro 22 and the vehicle speed sensor 23, and matches the travel trajectory to the road shape data of the road on which the vehicle C is traveling. If there is any deviation between the travel trajectory and the road shape, then the main CPU 10 identifies the calculated host vehicle position at an appropriate position on the road so that the travel trajectory follows the road shape.

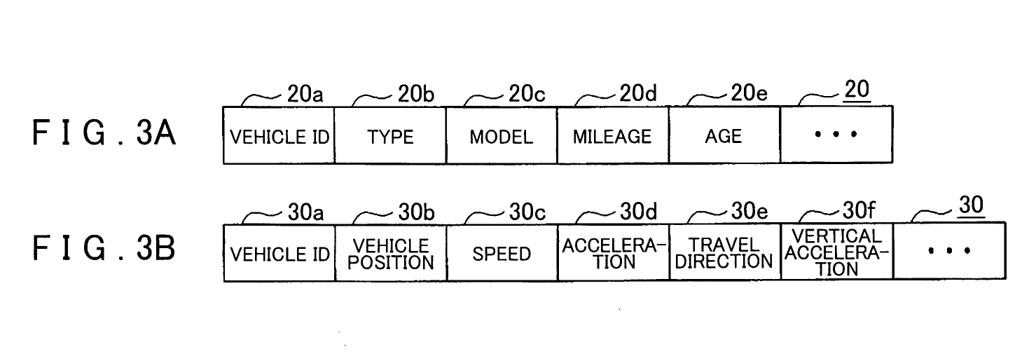

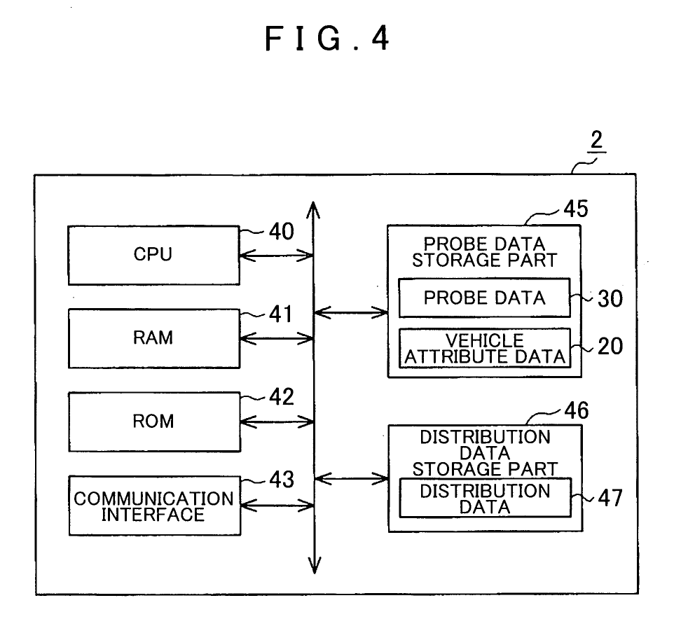

The attribute data storage part 17 stores vehicle attribute data 20. The vehicle attribute data 20 is data that specifies attributes of the vehicle C in which the navigation device 5 is installed. As shown in FIG. 3A, the vehicle attribute data 20 has a vehicle ID 20a, a type 20b, a model 20c, a mileage 20d, and an age 20e. The vehicle ID 20a is an identifier assigned in advance to the vehicles C. The type 20b specifies a vehicle type such as sedan, minivan, station wagon, and the like, of the vehicle C. The model 20c stores a vehicle name of the vehicle C. The mileage 20d stores a cumulative mileage of the vehicle C. The age 20e specifies a number of years that have passed since the vehicle C was first registered.

The navigation device 5 sends probe data 30, which acts as probe information specifying vehicle behavior during travel, to the statistical server 2. In the present example, when the vehicle C passes over a step on the road, the navigation device 5 sends the probe data 30 indicating detection of a step; however, the probe data 30 may be sent at predetermined times. Specifically, based on the magnitude of the vertical acceleration detected by the vertical acceleration sensor 24, the main CPU 10 determines that the vehicle C has passed over a step and generates the probe data 30, and reads out the vehicle attribute data 20 from the attribute data storage part 17. The generated probe data 30 is then sent to the statistical server 2 along with the vehicle attribute data 20 via the communication I/F 14.

As shown in FIG. 3B, the probe data 30 has a vehicle ID 30a, a vehicle position 30b, a speed 30c, an acceleration 30d, a travel direction 30e, and a vertical acceleration 30f. The vehicle position 30b is a vehicle position when the step is detected. The speed 30c and the acceleration 30d are a speed and an acceleration when the step is passed over. The acceleration 30d may be obtained from a G sensor (not shown) or calculated based on the vehicle speed. The travel direction 30e specifies a direction of movement of the vehicle C. The vertical acceleration 30f is obtained from the vertical acceleration sensor 24 and is the vertical acceleration when the step is passed over.

Note that the magnitude of the vertical acceleration 30f when passing over the step is influenced by factors such as the type and the model of the vehicle C, in addition to the mileage 20d and the age 20e of the vehicle C, as well as the speed 30c and the acceleration 30d when passing over the step. Namely, a vibration experienced when passing over the same step differs between the vehicle C of the sedan type and a vehicle of the compact car type due to differences in body shape and the like. Even for different models of the same vehicle type, the vertical acceleration varies because of differences in the mounted suspension mechanisms. A greater mileage 20d or an older age 20e also means more aged deterioration of the vehicle C, and therefore the vertical acceleration also differs depending on the mileage 20d and the age 20e. A faster speed 30c and acceleration 30d increases the vertical acceleration when passing over the step as well. As a consequence, the vertical acceleration 30f included in the probe data 30 sent from the navigation device 5 is a different value depending on the above factors.

The image processor 15 displays various screens such as the map screen 25a, a setting screen, a warning screen, and the like on the display 25. The audio processor 26 outputs audio such as audio guidance for guiding along a route from a speaker 27 and audio for drawing the driver's attention.

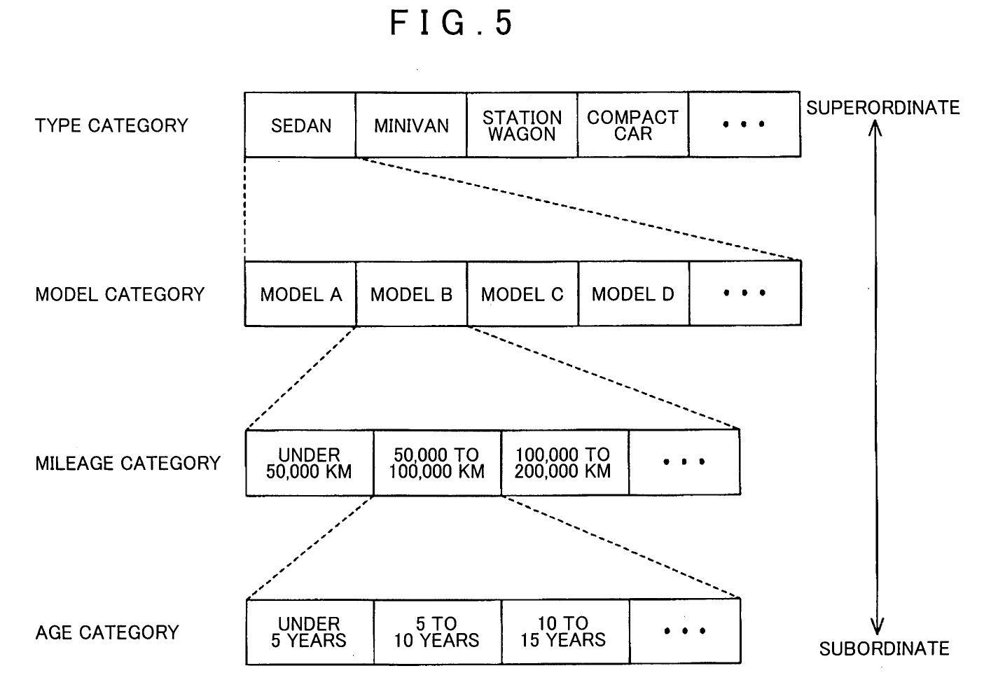

A configuration of the exemplary statistical server 2 will be explained next with reference to FIG. 4. The statistical server 2 includes a controller (CPU 40), a RAM 41, a ROM 42, a communication interface (I/F) 43, a probe data storage part 45 acting as a probe information storing unit, and a distribution data storage part 46.

The CPU 40 calculates the statistics of the probe data 30 obtained from the navigation device 5, for example, based on a statistics program stored in the ROM 42. The probe data 30 obtained from the navigation device 5 is associated with the vehicle attribute data 20 and stored in the probe data storage part 45.

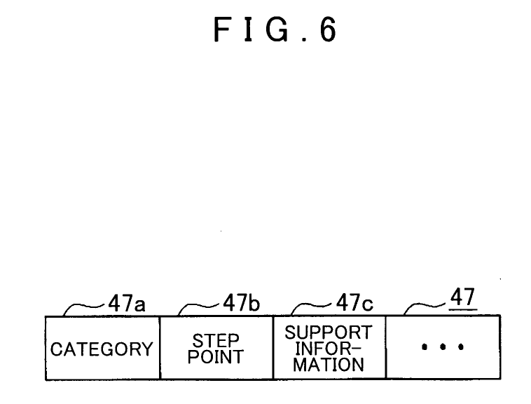

In accordance with the stored statistics program and based on preset categories, the CPU 40 calculates a data quantity (an accumulated quantity) of the probe data 30 for each category. In the present example, among the data included in the vehicle attribute data 20, the categories are the type 20b, the model 20c, the mileage 20d, and the age 20e, which are divided into a hierarchy of four levels, as shown in FIG. 5. The highest ranked category is the type category, which includes the categories of a sedan, a minivan, a station wagon, and a compact car, for example.

The type categories are further respectively associated with model categories belonging in the applicable type category. For example, the sedan category is associated with categories of vehicle names belonging to that type, such as model A and model B. The model categories are further respectively associated with mileage categories. The mileage category includes categories of distance ranges such as under 50,000 km, and from 50,000 km to under 100,000 km. The mileage categories are also associated with age categories belonging in the applicable mileage category. The age category includes categories of under 5 years, and from 5 year to under 10 years.

When calculating the data quantity for each category, the CPU 40 first calculates the data quantity for each type category, i.e., the highest rank of the hierarchy. Namely, when calculating the data quantity of the probe data 30 obtained from the vehicle C that is a sedan, the CPU 40 detects the vehicle attribute data 20 which includes the type 20b indicating the sedan type, and reads out the probe data 30 associated with the vehicle attribute data 20, after which the CPU 40 counts the data quantity. Additionally, the data quantity is counted in the same manner for other type categories such as the minivan and station wagon.

Next, the CPU 40 determines whether the data quantities for each type category are equal to or greater than a predetermined number N. Note that the predetermined number N is found by calculating in advance a number with which it is estimated that a sufficient data quantity can be obtained regardless of the category subject to statistical processing.

For the type categories whose data quantity is less than the predetermined number N, statistical processing is performed on the probe data 30 for each type category. At such time, based on the probe data 30 collected from the vehicle C of the sedan type and regardless of the model and mileage, data is extracted where the vehicle position 30b at which a step was detected is within a set range. A mean value or a median value of the vehicle positions 30b at which steps were detected are computed or the like to identify a point at which there is a step. Furthermore, a correlation among the speed 30c, the acceleration 30d, and the vertical acceleration 30f may be found, and a recommended speed and a recommended damping force calculated to ensure that vibrations generated when passing over the step are of a degree that does not cause an occupant discomfort. Alternatively, a vertical acceleration value that specifies a size of the step may be calculated. Such information is designated as distribution data 47, and the distribution data 47 is stored in the distribution data storage part 46.

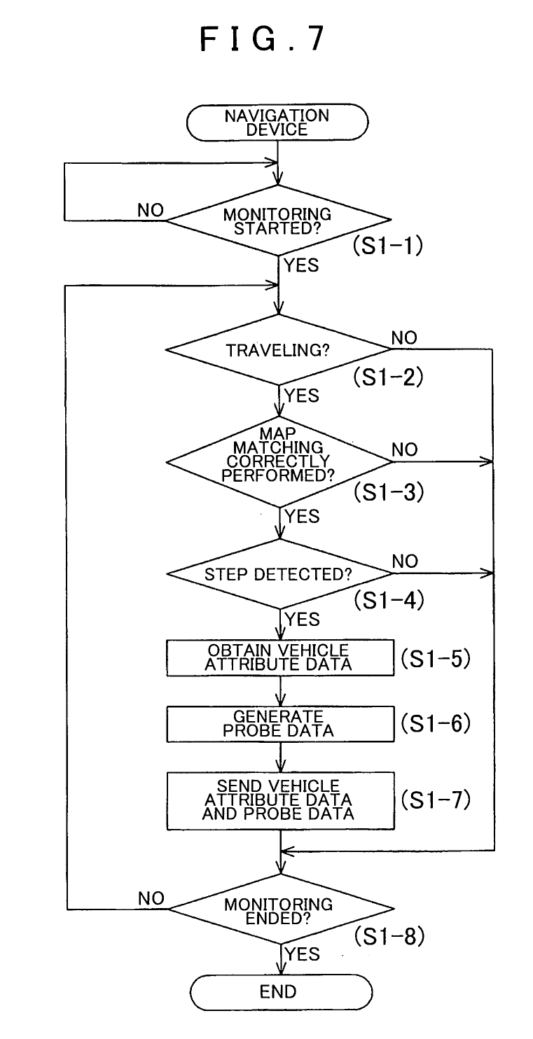

In the present example, the distribution data 47 includes at least a category 47a specifying that the vehicle C is a target for distribution of the distribution data 47, a step point 47b, and support information 47c, as shown in FIG. 6. If the probe data 30 subjected to statistical processing corresponded to the sedan type, then the category 47a stores a category specifying sedan. The step point 47b stores coordinates that specify a step portion according to the statistical processing. The support information 47c stores driving support information regarding when the vehicle C of the sedan type passes over the step. For example, the recommended speed, recommended damping force, magnitude of vertical acceleration, and the like as mentioned above are stored.

The statistical server 2 sends the distribution data 47 to the vehicle C traveling within a predetermined distance range centered around the step point 47b specified in the distribution data 47. The predetermined distance range may be within a radius of a predetermined distance whose center point is the step point 47b, or may be within a set distance range following a road that includes the step point 47b. At such time, the distribution data 47 may be sent at random to the vehicle C within the predetermined distance range, and it is determined on the vehicle side whether data among the distribution data 47 can be used by the host vehicle based on the category 47a. Alternatively, the vehicle C may send its vehicle attribute data 20 to the statistical server 2 in advance, after which the distribution data 47 for the vehicle C of the same category 47a is sent.

Meanwhile, if the data quantity of the probe data 30 for the type category is equal to or greater than the predetermined number N, then it is determined that a sufficient data quantity is accumulated. Since information more in line with the vehicle characteristics can be provided, the data quantity for each category of lower rank in the hierarchy is further calculated. In other words, the data quantities of the probe data 30 obtained from the vehicle C of model A, model B, etc., which are lower ranked categories belonging to the sedan category, are respectively calculated as described above.

The CPU 40 then determines whether the data quantity of the probe data 30 collected from the vehicle C of the model A is equal to or greater than the predetermined number N. If less than the predetermined number, statistical processing is performed on the probe data 30 belonging to the model A category as explained above to generate the distribution data 47.

If it is determined that the data quantity of the probe data 30 collected from the vehicle C of the model A is equal to or greater than the predetermined number N, then the data quantity of the mileage categories which are ranked lower than the model category is further calculated. In this manner, the statistical server 2 calculates the data quantities of the respective categories and selects a category for generating the distribution data 47.

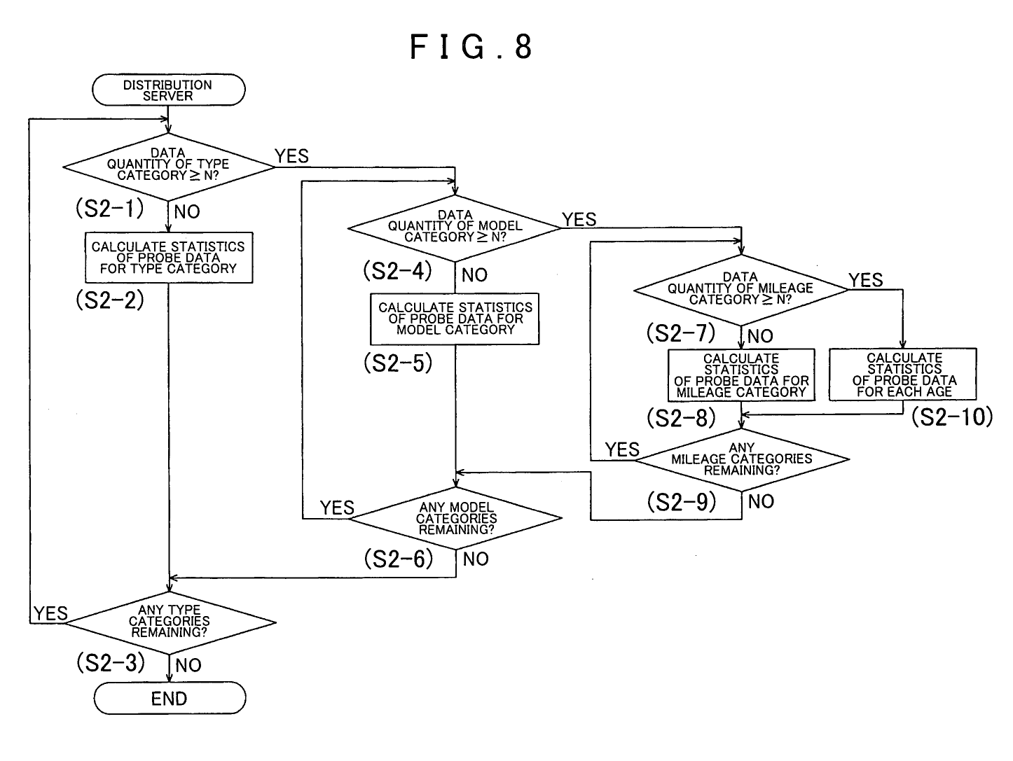

Processing according to the present example will be explained next with reference to FIGS. 7 to 9. An exemplary data collection method will be explained first with reference to FIG. 7. The exemplary method may be implemented, for example, by one or more components of the above-described system 1. For example, the exemplary method may be implemented by the CPU 10 of the navigation apparatus 5 executing a computer program stored in the ROM 12. However, even though the exemplary structure of the above-described system may be referenced in the description, it should be appreciated that the structure is exemplary and the exemplary method need not be limited by any of the above-described exemplary structure.

As shown in FIG. 7, the navigation device 5 first determines whether monitoring is started (step S1-1). Monitoring is determined to be started if the navigation device 5 is activated, if an ON signal is input from an ignition, or if a predetermined operation switch is turned on, for example (YES at step S1-1). If it is determined that monitoring is not started (NO at step S1-1), then the method waits for activation of the navigation device 5, input of the ON signal from the ignition, or turning on of the predetermined operation switch.

The main CPU 10 of the navigation device 5 next determines whether the vehicle C is traveling (step S1-2). At such time, based on a detection signal input from a shift position sensor for example, the vehicle C may be determined as traveling if the shift position is in a position other than a parking position. If it is determined at step S1-2 that the vehicle C is not traveling (NO at step S1-2), then the method proceeds to step S1-8

If the vehicle C is determined as traveling (YES at step S1-2), then the main CPU 10 determines whether map matching is being correctly performed (step S1-3). If the travel trajectory of the vehicle C is following the road shape, then it is determined that the map matching is being correctly performed (YES at step S1-3), and the method proceeds to step S1-4. If the travel trajectory of the vehicle C does not follow the road shape, then it is determined that the map matching is not being correctly performed (NO at step S1-3), and the method proceeds to step S1-8.

Meanwhile at step S1-4, the main CPU 10 determines whether a step on the road is detected based on the vertical acceleration input from the vertical acceleration sensor 24. If it is determined, for example, that the vertical acceleration is equal to or greater than a predetermined value and the vertical acceleration equal to or greater than the predetermined value is detected, then it is determined that the vehicle C has passed over a step.

If a step is not detected (NO at step S1-4), then the routine proceeds to step S1-8. If it is determined that a step is detected (YES at step S1-4), then the main CPU 10 determines, reads out, and obtains the vehicle attribute data 20 from the attribute data storage part 17 (step S1-5). After obtaining the vehicle position 30b, the speed 30c, the acceleration 30d, the travel direction 30e, and the vertical acceleration 30f based on the GPS receiving part 21, the vehicle speed sensor 23, the gyro 22, the vertical acceleration sensor 24, and the like, the main CPU 10 generates the probe data 30 (step S1-6). Furthermore, the vehicle attribute data 20 and the probe data 30 are sent via the communication I/F 14 to the statistical server 2 via the base station 3 (step S1-7). Once the statistical server 2 receives the vehicle attribute data 20 and the probe data 30, the statistical server 2 associates the vehicle attribute data 20 and the probe data 30, which are then stored in the probe data storage part 45.

Once the vehicle attribute data 20 and the probe data 30 are sent, the main CPU 10 of the navigation device 5 determines whether monitoring is ended (step S1-8). The main CPU 10 determines that monitoring is ended if the navigation device 5 is shut down, if an OFF signal is input from the ignition, if a signal indicating an OFF operation of the predetermined operation switch is input, or the like. If it is determined that the monitoring as described above is ended (YES at step S1-8), then the processing is ended. If it is determined that the monitoring is not ended (NO at step S1-8), then the routine returns to step S1-2 and the above processing is repeated.

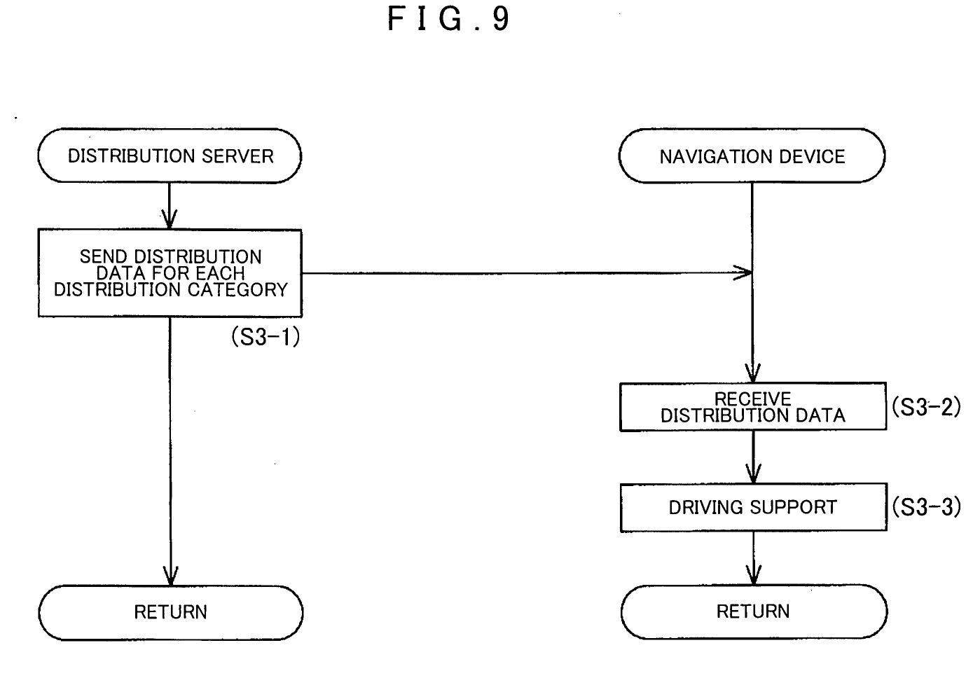

An exemplary statistical processing method will be described with reference to FIG. 8. The exemplary method may be implemented, for example, by one or more components of the above-described system 1. For example, the exemplary method may be implemented by the CPU 40 of the statistical server 2 executing a computer program stored in the ROM 42. However, even though the exemplary structure of the above-described system 1 may be referenced in the description, it should be appreciated that the structure is exemplary and the exemplary method need not be limited by any of the above-described exemplary structure.

The statistical server 2 may execute this method in the form of a program at a predetermined time interval, or execute the program when the data quantity of the newly received probe data 30 is equal to or greater than the predetermined number.

First, the CPU 40 of the statistical server 2 calculates the data quantity of the probe data 30 of a first/next type category stored in the probe data storage part 45. It is then determined whether the data quantity is equal to or greater than the predetermined number N (step S2-1). For example, the probe data 30 belonging to the sedan type category is detected, and the data quantity of the probe data 30 is calculated.

If the data quantity belonging to the sedan category is less than the predetermined number N (NO at step S2-1), then the statistics of the probe data 30 belonging to the sedan category are calculated as described above and the distribution data 47 is generated having the category 47a that indicates the sedan type (step S2-2). The generated distribution data 47 is subsequently stored in the distribution data storage part 46. The routine then proceeds to step S2-3, where it is determined whether there are any type categories remaining (step S2-3). Here, since the processing is only executed for the sedan category (NO at step S2-3), the routine returns to step S2-1, where the above processing is performed for the next type category, i.e., the minivan category. If there are no remaining type categories, namely, if the processing is ended for all the type categories (NO at step S2-3), then the method ends.

Meanwhile, if the data quantity belonging to the sedan category is equal to or greater than the predetermined number N (YES at step S2-1), then it is determined whether the data quantity of a first/next model category belonging to the sedan category is equal to or greater than the predetermined number N (step S2-4). First, the CPU 40 selects a category such as a model J category according to a predetermined order from among the model categories belonging to the sedan category, and calculates the data quantity of the probe data 30 belonging to the model J category. The CPU 40 further determines whether the applicable data quantity is equal to or greater than the predetermined number N. If the data quantity belonging to the model J category is less than the predetermined number N (NO at step S2-4), then the statistics of the probe data 30 belonging to the model J category are calculated, and the distribution data 47 assigned to the model J category is generated and stored (step S2-5).

Once the distribution data 47 for model J is generated, it is determined whether there are any model categories remaining whose data quantity has not been calculated among the categories ranked lower than the sedan category (step S2-6). If there are other model categories such as model J, model K, and model L ranked lower the sedan category and only the data quantity for model J has been calculated for example, then it is determined that there are categories remaining (YES at step S2-6) and the method returns to step S2-4, where the data quantity of the probe data 30 belonging to the model K category is calculated next. Once the data quantity is calculated, the CPU 40 determines whether the applicable data quantity is equal to or greater than the predetermined number N. If it is determined at step S2-6 that there are no model categories remaining (NO at step S2-6), then the method proceeds to step S2-3 described above.

If it is determined at step S2-4 that the data quantity of the model K category is equal to or greater than the predetermined number N (YES at step S2-4), then the CPU 40 calculates the data quantity a first/next mileage category belonging to the model K category and determines whether the data quantity is equal to or greater than the predetermined number N (step S2-7). For example, if there are the categories of under 50,000 km, from 50,000 km to under 100,000 km, and from 100,000 km to under 200,000 km ranked lower than the model K category, then the CPU 40 first selects the under 50,000 km category and calculates the data quantity of the probe data 30 belonging to the category. The CPU 40 further determines whether the calculated data quantity is equal to or greater than the predetermined number N.

If the data quantity belonging to the under 50,000 km category ranked lower than the model K category is less than the predetermined number N (NO at step S2-7), then the statistics of the probe data 30 belonging to the under 50,000 km category are calculated, and the distribution data 47 assigned to the under 50,000 km category is generated (step S2-8). Following storage of the generated distribution data 47 in the distribution data storage part 46, the CPU 40 determines whether there are any mileage categories remaining that belong to the model K category (step S2-9). If only the data quantity for the under 50,000 km category is calculated, then it is determined that the other mileage categories of from 50,000 km to under 100,000 km, and from 100,000 km to under 200,000 km are remaining categories (YES at step S2-9), and the routine returns to step S2-7. If it is determined at step S2-9 that there are no mileage categories remaining (NO at step S2-9), then the method proceeds to step S2-6 described above.

If the data quantity is equal to or greater than the predetermined number N (YES at step S2-7), then the CPU 40 calculates the statistics of the probe data 30 for each age (step S2-10). Namely, statistical processing is performed for the probe data 30 belonging to the respective age categories of under 5 years, from 5 years to under 10 years, from 10 years to under 15 years, and so on ranked lower than the from 50,000 km to under 100,000 km category. The distribution data 47 is then generated for the categories of under 5 years, from 5 years to under 10 years, from 10 years to under 15 years, and so on.

Following the storage of the distribution data 47 in this manner, the method proceeds to step S2-9, where it is determined whether the data quantities of all the mileage categories have been calculated. If calculation of the data quantities is complete (NO at step S2-9), then the method proceeds to step S2-6, where it is determined whether there are any model categories remaining. If there are model categories remaining (YES at step S2-6), then the method proceeds to step S2-4. If there are no model categories remaining (NO at step S2-6), then the method proceeds to step S2-3.

If the processing has been executed for all the type categories of sedan, minivan, station wagon, and so on (NO at step S2-3), then the processing of the category settings is ended. As a consequence, the distribution data storage part 46 stores the distribution data 47 corresponding to the accumulated quantity of probe data 30.

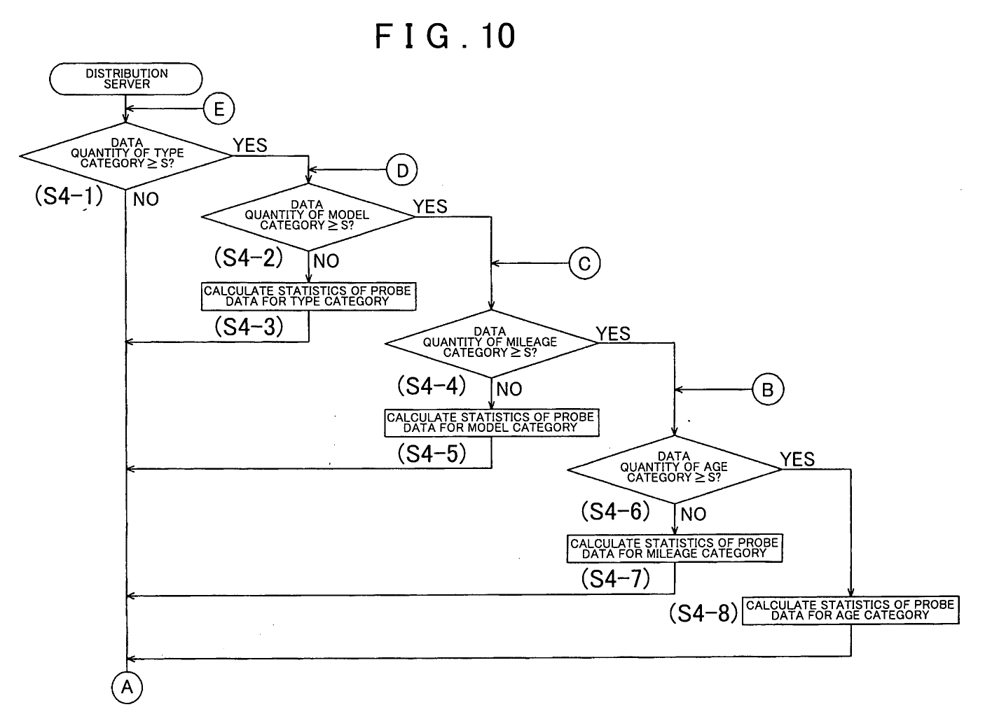

Next, an exemplary distribution data sending method will be described with reference to FIG. 9. The exemplary method may be implemented, for example, by one or more components of the above-described system 1. For example, the exemplary method may be implemented by the CPU 10 and/or CPU 40 executing a computer program(s) stored in the ROM 12 and/or ROM 42. However, even though the exemplary structure of the above-described system 1 may be referenced in the description, it should be appreciated that the structure is exemplary and the exemplary method need not be limited by any of the above-described exemplary structure.

As shown in FIG. 9, the statistical server 2 sends the distribution data 47 for each category to the navigation device 5 (step S3-1). The navigation device 5 receives the distribution data 47 (step S3-2). Based on the category 47a, the navigation device 5 then extracts data among the distribution data 47 determined as usable by the host vehicle, and uses the extracted data to give driving support (step S3-3). For example, the main CPU 10 of the navigation device 5 determines whether there is a step ahead of the host vehicle based on the step point 47b included in the extracted data. If it is determined that there is a step ahead of the host vehicle, then such information is communicated to the driver or a vehicle control performed based on the support information 47c. If communicated to the driver, then the display 25 displays a warning screen indicating that there is a step, and the speaker 27 outputs audio to draw attention to the step. Thus, the driver can decelerate before passing over the step and lessen the impact while passing over the step.

If a vehicle control is performed based on the distribution data 47, then a brake device (not shown) is controlled to apply a braking force to vehicle wheels and decelerate to the recommended speed included in the support information 47c. Alternatively, a suspension damping force is adjusted to the recommended damping force included in the support information 47c. Furthermore, in cases where the distribution data 47 includes the vertical acceleration that indicates the size of the step, the navigation device 5 may determine a required deceleration and adjust the speed accordingly or the like depending on the size of the step. Thus, it is possible to automatically mitigate the impact when passing over the step.

According to the above example, the statistical server 2 obtains the vehicle attribute data 20, which specifies attributes of the vehicle C, and the probe data 30, which measured vehicle behavior that varies depending on the vehicle attributes, from the navigation device 5. The statistical server 2 stores the vehicle attribute data 20 and the probe data 30 in the probe data storage part 45. In addition, the data quantity of the probe data 30 is obtained for each vehicle attribute category, namely, type, model, and the like. The size of the category for which the statistics of the probe data 30 are calculated is then determined in accordance with the data quantity. The statistics of the probe data 30 belonging to the category targeted for statistical processing are subsequently calculated, and the distribution data 47 corresponding to the vehicle attributes is generated. The distribution data 47 is then sent to the navigation device 5 belonging to the applicable category. In other words, since the category hierarchy is set depending on the data quantity, it is possible to send the distribution data 47 that matches the attributes of the vehicles C with good accuracy, while also suppressing statistical errors in the step point and the support information.

Further, according to the above example, the probe data 30 is divided into a hierarchy of four categories of type, model, mileage, and age. Also, if the data quantity of the probe data 30 belonging to a certain category is less than a predetermined number, then the statistical server 2 targets that category for statistical processing. If the data quantity is equal to or greater than the predetermined number, then the category is further broken down and the data quantity of the probe data 30 belonging to a lower ranked category is obtained. Based on the applicable data quantity, it is determined whether the lower ranked category is a target for statistical processing. In other words, if the data quantity is large, then the category is narrowed down to a small range. Therefore, the distribution data 47 in line with vehicle characteristics can be sent while also maintaining well the accuracy of the distribution data 47.

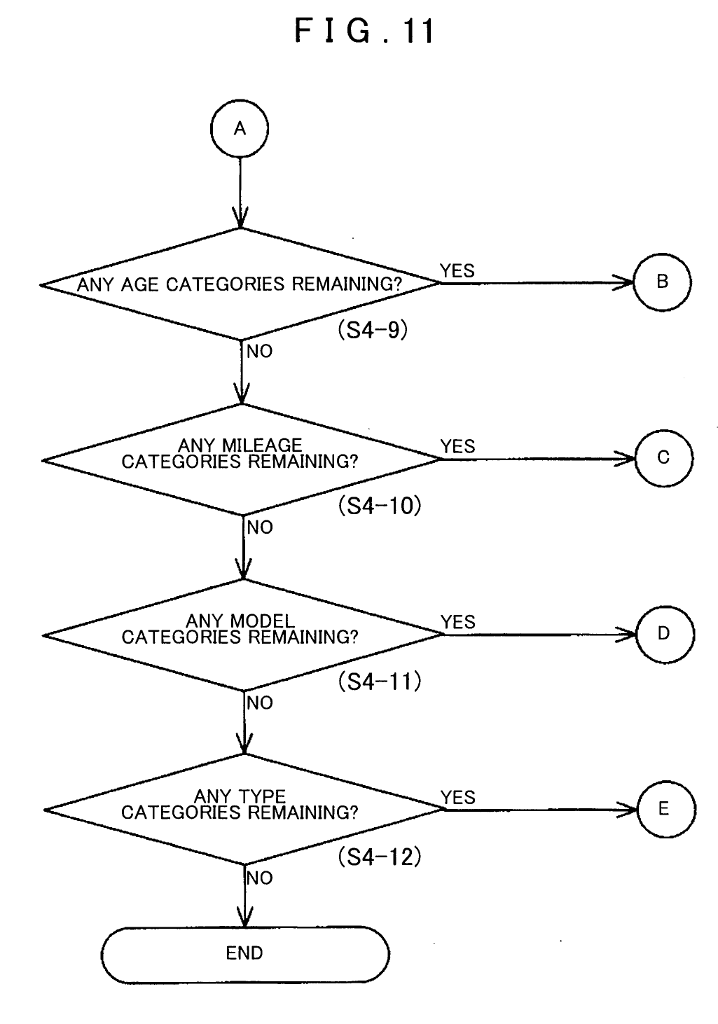

Another example of processing will be described with reference to FIGS. 10 to 11. Detailed descriptions of like portions similar to the above example are omitted. According to this second example, if the data quantity of the probe data 30 belonging to a category is less than a threshold value S (a predetermined number), then a category ranked higher than the category is targeted for statistical processing. Note that the threshold value S is set according to a value calculated as a data quantity required for performing statistical processing based on an error tolerance, a required degree of reliability, and the like.

An exemplary statistical processing method will be described with reference to FIGS. 10 and 11. The exemplary method may be implemented, for example, by one or more components of the above-described system 1. For example, the exemplary method may be implemented by the CPU 40 of the statistical server 2 executing a computer program stored in the ROM 42. However, even though the exemplary structure of the above-described system 1 may be referenced in the description, it should be appreciated that the structure is exemplary and the exemplary method need not be limited by any of the above-described exemplary structure.

As shown in FIG. 10, the CPU 40 of the statistical server 2 determines whether the data quantity with respect to one type category is equal to or greater than the threshold value S (step S4-1). If the data quantity is less than the threshold value S (NO at step S4-1), then the processing is not performed for the type category and the method proceeds to step S4-9.

If the data quantity belonging to the type category is equal to or greater than the threshold value S (YES at step S4-1), then the CPU 40 moves to a lower ranked category for which it is determined whether the data quantity sorted for the model category belonging to the type category is equal to or greater than the threshold value S (step S4-2). If the data quantity is less than the threshold value S (NO at step S4-2), then the CPU 40 moves up to the category one rank higher and calculates the statistics of the probe data 30 belonging to the type category (step S4-3). For example, if the data quantity belonging to the minivan category is equal to or greater than the threshold value S and the data quantity of the model A category belonging to the minivan category is less than the threshold value S, then the minivan category is targeted for statistical processing.

Meanwhile, if the data quantity belonging to the above model category is equal to or greater than the threshold value S (YES at step S4-2), then it is determined whether the data quantity of the mileage category is equal to or greater than the threshold value S (step S4-4). If the data quantity is less than the threshold value S (NO at step S4-4), then the CPU 40 moves up to the category one rank higher and calculates the statistics of the probe data 30 belonging to the model category (step S4-5). If the data quantity is equal to or greater than the threshold value S (YES at step S4-4), then it is determined whether the data quantity of the age category belonging to the model category is equal to or greater than the threshold value S (step S4-6).

If the data quantity belonging to the age category is less than the threshold value S (NO at step S4-6), then the CPU 40 targets the mileage category for statistical processing and calculates the statistics of the probe data 30 (step S4-7). If the data quantity belonging to the age category is equal to or greater than the threshold value S (YES at step S4-6), then the CPU 40 targets, for example, the age category of under 5 years for statistical processing and calculates the statistics of the probe data 30 (step S4-8).

After one category is set, the method proceeds to step S4-9 shown in FIG. 11, where it is determined whether there are any age categories remaining, such as from 5 years to under 10 years, and from 10 years to under 15 years. In cases such as when there are no other age categories remaining besides the age category subjected to statistical processing at step S4-8, or the model category was set at step S4-5, and if the category calculated immediately prior is a category other than age (NO at step S4-9), then the method proceeds to step S4-10. Meanwhile, if there are age categories remaining (YES at step S-9), then the method returns to step S4-6, where the processing is repeated until the statistics of all the age categories of the same rank are calculated.

At step S4-10 it is determined whether there are any mileage categories remaining. If there are mileage categories remaining (YES at step S4-10), then the method proceeds to step S4-4. If there are no categories remaining or if a category ranked higher than the mileage category is a target for statistical processing (NO at step S4-10), then the method proceeds to step S4-11.

At step S4-11 it is determined whether there are any model categories remaining. If there are model categories remaining (YES at step S4-11), then the method proceeds to step S4-2. If there are no categories remaining or if a category ranked higher than the model category is a target for statistical processing (NO at step S4-11), then the method proceeds to step S4-12.

At step S4-12 it is determined whether there are any type categories remaining. If there are type categories remaining (YES at step S4-12), then the method proceeds to step S4-1. If there are no categories remaining (NO at step S4-12), this signifies that all the categories are set and the processing is ended.

In addition to the advantages of the first example, according to the second example, the probe data 30 is divided into a hierarchy of four categories of type, model, mileage, and age. Also, if the data quantity of the probe data 30 belonging to a certain category is less than the threshold value S, then the statistical server 2 targets a category one rank higher to which that category belongs for statistical processing. Therefore, it is possible to maintain the minimum data quantity required for statistical processing. As a consequence, the distribution data 47 in line with vehicle characteristics can be sent while also maintaining well the accuracy of the distribution data 47.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, the onboard device may be realized by a device provided separately from the navigation device 5.

In the above examples, when the vehicle C passes over a step, the probe data 30 indicating vehicle behavior such as the speed 30c and the vertical acceleration 30f when passing over the step are sent. However, other data that indicates vehicle behavior depending on the road may be sent. For example, the probe data 30 that includes an operation condition of the Antilock Brake System (ABS) may be sent. In such case, the statistical server 2 sets the size of the category targeted for statistical processing based on the data quantities for each category, and sends the distribution data 47 that includes the coordinates of a slip point, a recommended speed, and the like calculated based on the operating condition of the ABS.

If driving assistance is performed based on the distribution data 47, then after the vehicle C passes over the step the probe data 30 may be fed back to the statistical server 2 along with data indicating that driving assistance was executed. Based on this probe data 30, the statistical server 2 may refer to the speed 30c, the vertical acceleration 30f, and the like if driving assistance was executed to determine whether the distribution data 47 is accurate.

In the above examples, the categories were divided into the four ranks of type, model, mileage, and age. However, categories such as emissions and drive system may be used instead depending on the support content. The categories may also have a different hierarchy of other than four ranks.

What is claimed is:

1. A statistical processing server that obtains probe information from an onboard device in a vehicle and performs statistical processing on the probe information, the statistical processing server comprising:
a memory;
a communication interface that receives data from the onboard device; and
a controller specifically configured to:
obtain a vehicle attribute that specifies an attribute of the vehicle and probe information indicating a state of the vehicle from the received data;
accumulate the probe information in the memory;
obtain an accumulated quantity of the probe information for each of a plurality of categories included in the vehicle attribute;
determine one of the plurality of categories for which statistics of the probe information will be calculated based on the accumulated quantity of the probe information;
calculate the statistics of the probe information of the determined category;
generate distribution data based on the calculated statistics; and
send the distribution data to the onboard device of the vehicle belonging to the determined category.

2. The statistical processing server according to claim 1, wherein the obtained probe information indicates a measured vehicle behavior.

3. The statistical processing server according to claim 1, wherein:
the plurality of categories have a hierarchy, and
the controller is specifically configured to:
targets an identified one of the plurality of categories for statistical processing when the accumulated quantity of the probe information of the identified category is less than a predetermined number; and
targets one of the plurality of categories for statistical processing ranked lower than the identified category when the accumulated quantity of the probe information of the identified category is equal to or greater than the predetermined number.

4. The statistical processing server according to claim 1, wherein:
the plurality of categories has a hierarchy, and
the controller is specifically configured to target one of the plurality of categories for statistical processing ranked higher than an identified one of the plurality of categories when the accumulated quantity of the probe information belonging to the identified category is less than a predetermined number.

5. The statistical processing server according to claim 1, wherein the plurality of categories include at least one of vehicle type, vehicle model, vehicle mileage, vehicle age, emissions, and drive system.

6. The statistical processing server according to claim 1, wherein the probe information includes at least one of vertical acceleration, vehicle acceleration, vehicle speed, vehicle location, travel direction, and brake operation condition.

7. A probe information collection and distribution method, comprising:
obtaining a vehicle attribute from an onboard device in a vehicle that specifies an attribute of the vehicle and probe information of a measured vehicle behavior;
accumulating the probe information in a memory;
obtaining an accumulated quantity of the probe information for each of a plurality of categories included in the vehicle attribute;
determining one of the plurality of categories for which statistics of the probe information will be calculated based on the accumulated quantity of the probe information; and
calculating the statistics of the probe information of the determined category;
generating distribution data based on the calculated statistics; and
sending the distribution data to the onboard device of the vehicle belonging to the determined category.

8. The probe information collection and distribution method according to claim 7, wherein the obtained probe information indicates a measured vehicle behavior.

9. The probe information collection and distribution method according to claim 7, wherein:
the plurality of categories have a hierarchy, and
the method further comprises:
targeting an identified one of the plurality of categories for statistical processing when the accumulated quantity of the probe information of the identified category is less than a predetermined number; and
targeting one of the plurality of categories for statistical processing ranked lower than the identified category when the accumulated quantity of the probe information of the identified category is equal to or greater than the predetermined number.

10. The probe information collection and distribution method according to claim 7, wherein:
the plurality of categories has a hierarchy, and
the method further comprises targeting one of the plurality of categories for statistical processing ranked higher than an identified one of the plurality of categories when the accumulated quantity of the probe information belonging to the identified category is less than a predetermined number.

11. The probe information collection and distribution method according to claim 7, wherein the plurality of categories include at least one of vehicle type, vehicle model, vehicle mileage, vehicle age, emissions, and drive system.

12. The probe information collection and distribution method according to claim 7, wherein the probe information includes at least one of vertical acceleration, vehicle acceleration, vehicle speed, vehicle location, travel direction, and brake operation condition.

13. A computer-readable storage medium storing a computer-executable program usable to collect and distribute probe information, the program comprising:
instructions for obtaining a vehicle attribute from an onboard device in a vehicle that specifies an attribute of the vehicle and probe information of a measured vehicle behavior;
instructions for accumulating the probe information in a memory;
instructions for obtaining an accumulated quantity of the probe information for each of a plurality of categories included in the vehicle attribute;
instructions for determining one of the plurality of categories for which statistics of the probe information will be calculated based on the accumulated quantity of the probe information;
instructions for calculating the statistics of the probe information of the determined category;
instructions for generating distribution data based on the calculated statistics; and
instructions for sending the distribution data to the onboard device of the vehicle belonging to the determined category.

14. The storage medium according to claim 13, wherein the obtained probe information indicates a measured vehicle behavior.

15. The storage medium according to claim 13, wherein:
the plurality of categories have a hierarchy, and
the program further comprises:
instructions for targeting an identified one of the plurality of categories for statistical processing when the accumulated quantity of the probe information of the identified category is less than a predetermined number; and
instructions for targeting one of the plurality of categories for statistical processing ranked lower than the identified category when the accumulated quantity of the probe information of the identified category is equal to or greater than the predetermined number.

16. The storage medium according to claim 13, wherein:
the plurality of categories has a hierarchy, and
the program further comprises instructions for targeting one of the plurality of categories for statistical processing ranked higher than an identified one of the plurality of categories when the accumulated quantity of the probe information belonging to the identified category is less than a predetermined number.

17. The storage medium according to claim 13, wherein the plurality of categories include at least one of vehicle type, vehicle model, vehicle mileage, vehicle age, emissions, and drive system.

18. The storage medium according to claim 13, wherein the probe information includes at least one of vertical acceleration, vehicle acceleration, vehicle speed, vehicle location, travel direction, and brake operation condition.
